(19) United States
(12) Patent Application Publication
(10) Pub. No.: US 2005/0046299 A1
(43) Pub. Date: Mar. 3, 2005

(54) Windings for electric machines

(76) Inventors: David L. Brown, Westfield, IN (US); Robert A. Lawrence, Frankfort, IN (US)

Correspondence Address: DELPHI TECHNOLOGIES, INC., M/C 480-410-202, PO BOX 5052, TROY, MI, 48007, US

(21) Appl. No.: 10/647,675

(22) Filed: Aug. 25, 2003

(51) Int. Cl. H02K 3/04; H02K 17/00; H02K 19/00; H02K 21/00

(52) U.S. Cl. 310/207; 310/214; 29/596; 29/606

(57) ABSTRACT

A stator core extends along a longitudinal axis and includes a plurality of radially-inwardly projecting teeth separated by intervening slots. Each tooth includes a tooth tip at the radially innermost portion of each tooth, thereby defining a slot opening. A wave-shaped conductor segment including a pair of segment ends having a first cross-section shape, a plurality of straight portions having a second cross-section shape and having a plurality of end-turn regions with a third cross-section shape disposed in between the straight portions in an alternating pattern is radially inserted into the stator core. After the conductor segment is inserted, the tooth tips are deformed so as to reduce the size of the slot opening, thereby providing for an improved magnetic flux path and slot fill percentage, as well as reduced cost and complexity without decreasing reliability.

### TECHNICAL FIELD

The present invention relates to a stator core of a dynamoelectric machine such as a generator or alternator, and in particular to a method for providing windings in stator cores with increased slot fill percentages and reduced coil end-turn heights.

### BACKGROUND OF THE INVENTION

Generators are found in virtually every motor vehicle manufactured today. These generators, also referred to as alternators, produce electricity necessary to power a vehicle's electrical accessories and charge a vehicle's battery. Generators must produce electricity in sufficient quantities to power a vehicle's electrical system. Furthermore, generators must produce electricity having the characteristics necessary to be compatible with a vehicle's electrical components. Further applications of the generator/alternator include providing sufficient torque for the starting of typical internal combustion engines. A generator typically includes a stator assembly comprising a stator core, stator windings, and a rotor.

Conventionally, the stator core contains the main current carrying windings (“stator windings”) in which electromotive force produced by magnetic flux is induced. The core contains a plurality of radially-inwardly projecting teeth separated by intervening slots. Each slot has an open end formed by tooth tips of adjacent stator teeth. The slot opening is conventionally relatively narrow, compared with the width of the slot itself. The narrow slot opening in conventional arrangements, however, is not an accident, but rather a deliberate choice, ostensibly to provide both a magnetic flux path and to provide for wire retention.

There are two basic ways in which conventional stator windings are manufactured. In the first instance, a continuous magnetic wire is wound into a wave or coiled pattern and then inserted into the slots of the stator core in primarily a radial direction. In the second instance, a number of hairpin-shaped conductor segments (i.e., including at least one “hairpin” or 180° end turn) are inserted axially into the stator core. After insertion, the two straight segment ends of the hairpin-shaped conductor segments extending out from the slots must be post formed into a correct position and shape and then joined to the segment ends of adjacent conductor segments in order to complete the electrical circuit. There are, however, shortcomings with these conventional arrangements.

The first shortcoming relates to a so-called “slot fill” factor, typically expressed as a percentage. Particularly, the “slot fill” is a percentage of the total cross-sectional area of stator windings, taken relative to the total available cross-sectional area in the slot. The relatively narrow slot opening formed by the tooth tips, which are typically stamped directly into a steel lamination into the desired profile, restricts entry (and accordingly the size) of the stator windings used in the generator. A typical stator size and fill configuration is shown in FIG. 11. Accordingly, obtaining an increased stator slot fill is difficult to achieve with current winding insertion technology. Due to this manufacturing constraint, the slot fill is typically in the range of 50% of the net available slot space for a Lundell type generator. This constraint limits both the output power of the generator, as well as its efficiency for a given package size.

One approach taken in the art to improve the “slot fill” of a generator is to use stator windings made up of hairpin-shaped conductor segments as discussed above. In this approach, pre-formed conductor segments are inserted axially into the stator slots throughout the iron core of the stator. The multiple segment ends of these hairpin-shaped conductor segments are then joined to create a continuous conductive loop in the stator. Since the conductor segments are inserted in an axial fashion, such hairpin-shaped conductor segments are not limited by such small slot openings known in the art. Consequently, the hairpin-shaped conductor segments can be of a larger cross-sectional area, and also be non-round in shape. With such a size and shape, it is possible to neatly stack the windings within the slot to increase the slot fill, which may approach 90%.

However, such an approach is not without its downfalls. For instance, because each hairpin-shaped conductor segment only occupies two slots, a large number of electrical connections between the segment ends of adjacent conductor segments is required in order to create a continuous stator winding. This results in significant cost increases due to increased labor, complexity and scrap rate, as well as decreased reliability. Additionally, because the cross-section of the end turn portion of the hairpin-shaped conductor is the same as that of the straight portions of the conductor in the slot, the end-turn segments of the conductors are unnecessarily tall, adding electrical resistance to the circuit, and unnecessarily increasing conductor usage and packaging requirements.

Another approach in the art involves deforming the tooth tips after inserting the hairpin-shaped conductor segments, as seen by reference to U.S. Pat. No. 4,176,444 entitled “METHOD AND APPARATUS FOR ASSEMBLING DYNAMOELECTRIC MACHINE STATORS” issued to Walker. Walker discloses a method for forming a stator including the steps of enlarging a slot opening between adjacent pairs of stator teeth by deforming the stator tooth tips (e.g., with a punch), placing prewound stator windings in selected core slots and thereafter reducing the slot opening between those certain adjacent pairs of teeth by reforming the tooth tips so as to provide a cylindrical shaped central bore stator. The disclosure of Walker, however, does not teach using a conductor having a width substantially equal to that of the slot itself.

Thus, in sum, it would be desirable to keep the “tooth tips” since they can improve low speed performance of the generator, among other things. However, the small slot opening which results from the “tooth tips” restricts the size of the stator windings, resulting in a low slot-fill stator having a reduced power output and a reduced efficiency. Additionally, it would be advantageous to utilize hairpin-shaped conductor segments in an effort to improve slot fill, however, the number of electrical connections required combined with the resulting excessive end turn height serves to increase the complexity and cost of winding the stator, as well as reducing reliability.

There is, therefore, a need to provide a method of making a dynamoelectric machine that minimizes or eliminates one or more of the problems set forth above.

### SUMMARY OF THE INVENTION

One object of the present invention is to provide a stator core for a dynamoelectric machine, such as an alternating current (AC) generator, that solves one or more of the problems set forth above. The present invention provides a method that, during an initial step, provides a stator slot opening that is increased in width relative to conventional slot openings (i.e., approximately equal to the width of the slot itself). The increased size slot openings allow a wave-shaped conductor segment having a plurality of straight portions with end turn regions disposed in between adjacent straight portions in an alternating pattern to thereby define a pair of free segment ends on the outermost straight portions and positioned on the same axial side of the stator core, to be inserted (in a subsequent step) into the slots to thereby provide an increased slot fill and reliability, as well as a reduction in complexity and costs.

The wave-shaped conductor segments are formed in a manner wherein each of the two segment ends, the plurality of straight portions, and the end turn regions each have separate and distinct cross-section shapes. After the wave conductor segments have been formed to their desired shape, in one embodiment, the formed wave-shaped segments are loaded onto a tool that radially disposes the windings into the open slots of the stator. In alternate embodiments, the wave-shaped segments could be formed multiple ways: continuously, so that an entire phase of windings are formed in series requiring no post connections, or the formed waves could be manufactured in multiple parallel waves that would require a few post connections to complete the winding circuit for a given phase. Thereafter, in a subsequent step, the segment ends of adjacent wave-shaped stator windings are electrically connected in order to create a continuous stator winding, which results in a decreased number of required electrical connections, and which accordingly decreases the costs and complexity that exist in conventional arrangements. In a further subsequent step, the slot openings are closed up in order to provide an improved magnetic flux path and for winding retention. This is accomplished, in one embodiment, by cold-forming the ends of the stator teeth to form “tooth tips” after the core itself has been made and the wave-shaped conductor segments have been inserted into the open slots. The invention also provides another advantage, namely that of keeping the “tooth tips,” which improve performance, particularly at low speed.

A method according to the present invention thus involves providing a stator core having a plurality of teeth separated by intervening slots with a slot opening substantially equal to the slot width. The method further includes forming a continuous wave-shaped conductor segment having a plurality of straight portions with end turn regions disposed inbetween adjacent straight portions in an alternating pattern so as to define a pair of free segment ends on the outermost straight portions, and wherein the segment ends have a first cross-section shape, the straight portions have a second cross-section shape different than the first cross-section shape, and the end turn regions have a third cross-section shape different than both the first and second cross-section shapes. The method further includes inserting the wave-shaped conductor segment into the slots of the stator core.

Other features and advantages will be apparent to those of ordinary skill in the art from the detailed description and accompanying drawings describing and illustrating the invention by way of example only and not by way of limitation.

A stator core according to the present invention is also provided.

### BRIEF DESCRIPTION OF THE DRAWINGS

The operative features of the present invention are explained in more detail with reference to the drawings.

FIG. 1 is a front perspective view of a stator core suitable for use in the present invention.

FIG. 2 is a partial plan view of a stator core suitable for use in the present invention.

FIG. 3 is a plan view of a wave-shaped conductor segment suitable for use in the present invention.

FIG. 3a is a cross-sectional view of a wave-shaped conductor taken along the line 3a-3a in FIG. 3.

FIG. 4 is a plan view of a wave-shaped conductor segment with shaped straight portions in accordance with the present invention.

FIG. 4a is a cross-sectional view of a straight portion of a wave-shaped conductor suitable for the present invention taken along the line 4a-4a in FIG. 4.

FIG. 5 is a plan view of a wave-shaped conductor segment suitable with shaped straight portions and end turn regions in accordance with the present invention.

FIG. 5a is a cross-sectional view of an end-turn region of a wave-shaped conductor suitable for the present invention taken along the line 5a-5a in FIG. 5.

FIG. 6 is a partial perspective view of a of a stator on a radial insertion tool.

FIG. 7 is a partial perspective view of a stator core showing a wave-shaped conductor segment associated therewith.

FIG. 8 is perspective view of a stator with inserted windings in accordance with the present invention.

FIGS. 9-10 are simplified plan views of a pair of adjacent stator teeth illustrating the progression of deforming the tooth tips of the stator teeth.

FIG. 11 is a simplified cross-sectional view of a conventional stator arrangement.

FIG. 12 is perspective view of an assembled stator core in accordance with the present invention.

### DESCRIPTION OF PREFERRED EMBODIMENT

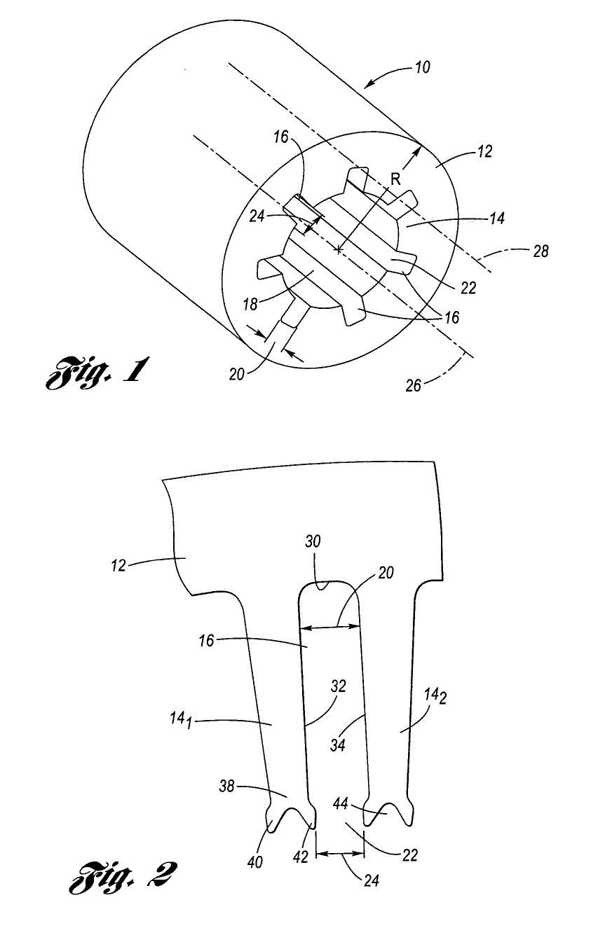

Referring now to the drawings wherein like reference numerals are used to identify identical components in the various views, FIG. 1 is a front perspective view of a stator core 10 suitable for use in accordance with the present invention. Core 10, as shown, includes yoke 12, a plurality of teeth 14, tooth tips (not shown), and a plurality of intervening slots 16. Each of teeth 14 project radially-inwardly, thereby defining a central bore 18. Each slot 16 has a nominal slot width 20, and a slot opening 22 having a width 24. The stator core 10 shown in FIG. 1 is that produced after a first stage of manufacturing, but prior to insertion of stator windings, and a cold-forming operation to form tooth tips, to be described in detail below.

With continued reference to FIG. 1, stator core 10 is generally cylindrical having a main longitudinal axis 26, a secondary axis 28 parallel to and radially offset from main axis 26 and extending through the axial length of slot 16, and an outside diameter of radius R, also as shown. Core 10 is suitable for use in a stator assembly for a dynamoelectric machine, such as an induction electric machine, or an AC generator for an automotive vehicle such as a Lundell type generator (i.e., an AC generator having claw-shaped rotor poles, the stator windings being wound in a multiphase configuration, such as a three phase configuration, and connected to a rectifier to produce a DC output). In a preferred embodiment, a plurality of relatively thin, generally circular laminations are stamped or otherwise formed from suitable magnetic material (e.g., silicon steel or the like), and are then adhered together in a stack having a predesired axial length, as understood generally by one of ordinary skill in the art. In a first preferred embodiment, the stator core 10 may be of the type having 72 slots. In a second preferred embodiment, the stator core 10 may be of the type having 36 slots. While these embodiments are preferred, it should be noted that they are meant to be merely exemplary and not limiting in nature.

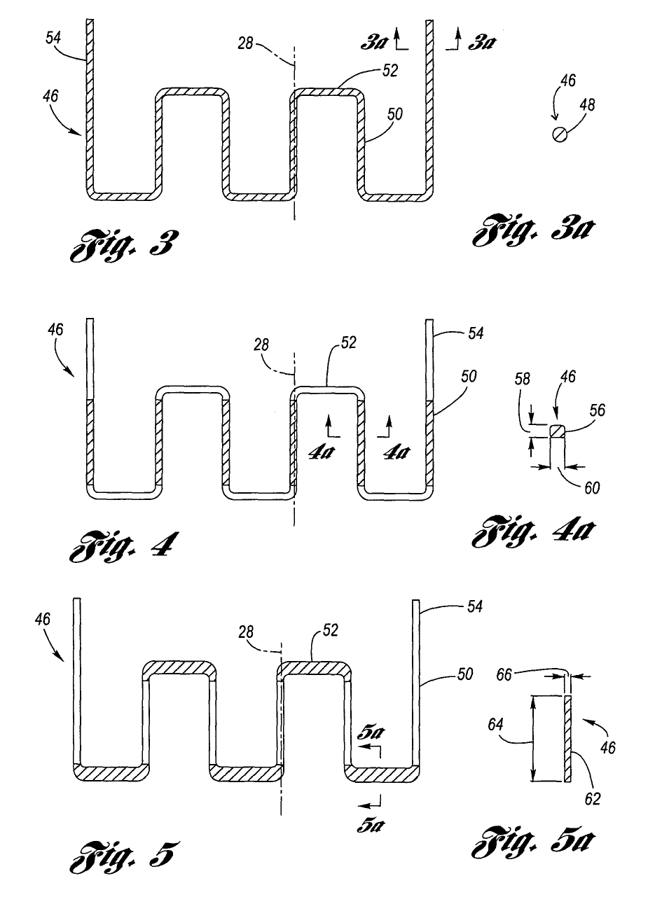

FIG. 2 is a partial view of a stator core suitable for use in the present invention. FIG. 2 shows the profile in an intermediate stage of construction, after formation of the stator core in a cylindrical shape but before insertion of the conductor segments and deformation of the tooth tips. Each slot 16 is formed by adjacent teeth, shown in FIG. 2 as adjacent teeth 14₁ and 14₂. Slot 16 is configured to receive stator windings of a type that have a width that is substantially equal to the slot width 20.

Slot 16 includes a closed end 30 adjacent to yoke 12 and a pair of sides 32 and 34 defined by adjacent teeth 14₁ and 14₂ (in addition to an open end defining slot opening 22 described in connection with FIG. 1). In the illustrated embodiment, sides 32 and 34 are generally parallel over the radial extent of teeth 14₁ and 14₂.

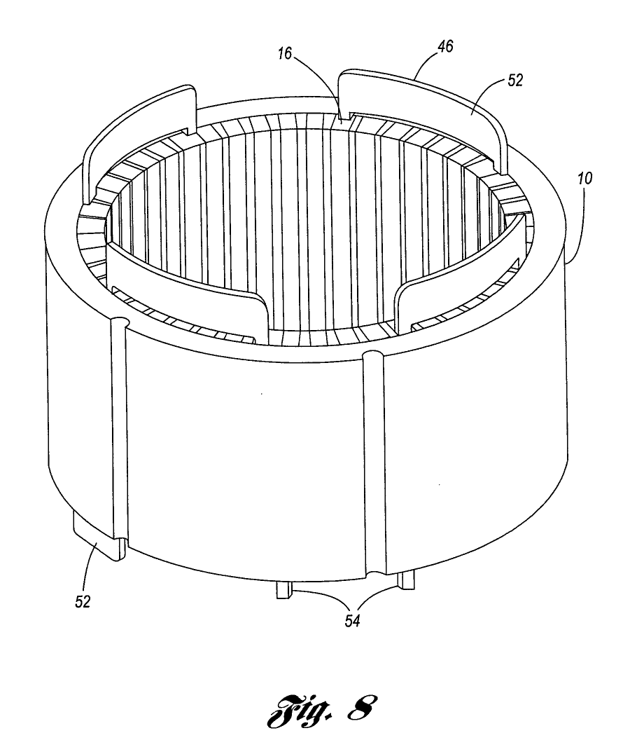

The depth of slot 16 may be selected to accept a plurality of stacked layers of individual stator winding conductors (as shown in FIG. 3 for example). In one constructed embodiment, a slot opening width 24 was about 0.1005 inches and a slot width 20 was about of 0.1205 inches. This difference of about 0.0200 inches in width allows for the insertion of an insulating material, such as a slot liner 36, best shown in FIGS. 7-9. These dimensions are, of course, exemplary only, and not limiting in nature. Thus, the stator slot opening width 24 is substantially equal to the width of one wire plus a suitable clearance between the wire and the slot liner 36. It should therefore be understood from the foregoing that the width of the stator winding, the slot opening width 24 and the slot width 20 need not each be of the identical dimension. In a constructed embodiment, for example, the slot opening 22 was about 83% of the slot width 20 (0.1005/0.1205), substantially equal for purposes of this invention. Of course, the slot liner 36 may be omitted, thereby allowing a much closer correspondence in size between the wire width, the opening width 24, and the slot width 20 itself. In general, it should be understood that the slot opening and the wire width will be closer numerically to each other with respect to the slot width, in the case where a slot liner is used.

The increased slot opening 22 is achieved by producing (e.g., stamping) the profile shown in FIG. 2, and deferring final formation of the small gap “tooth tips” until after the core 10 itself has been made (adhering laminations together) and wave-shaped conductor segments have been radially inserted according to the invention. To facilitate the step of forming the tooth tips, a variety of features are initially formed on a radially innermost portion of the plurality of teeth 14 (herein designated generally “first tips” 38 in FIG. 2). In particular, each tooth 14 includes (i) a pair of legs 40 and 42; (ii) a recess 44 disposed therebetween and formed, in part, by the inner sides of legs 40 and 42.

FIGS. 2-8 show the progression of a method of manufacturing a dynamoelectric machine according to the invention, which combines the insertion of a wave-shaped conductor segment 46 formed of a continuous conductor into the dynamoelectric machine, and a deforming process.

FIG. 2 shows the first step of the inventive method, namely, providing a stator core 10 having a main axis 26 (best shown in FIG. 1) including a yoke 12 and a plurality of radially-inwardly projecting teeth 14 separated by intervening slots 16 wherein a radially innermost portion of teeth 14₁ and 14₂ each include a pair of legs 40 and 42, with a recess 44 disposed between the legs. Legs on adjacent teeth define a plurality of slot openings 22 each having a first width 24.

FIGS. 3-3a show the next step of the inventive method, namely forming a wave-shaped conductor segment 46 comprised of a continuous conductor having a first cross-section shape 48. FIG. 3a is a cross-sectional view of conductor segment 46 as taken along the line 3a-3a in FIG. 3, and shows conductor segment 46 having a circular cross-section shape. This circular cross-section shape, however, is only exemplary and not meant to be limiting in nature (i.e., rectangular, alternately circular and rectangular). Wave-shaped conductor segment 46 further includes a plurality of straight portions 50 extending longitudinally along, and substantially parallel to secondary axis 28; end turn regions 52 extending substantially transverse to secondary axis 28, and disposed in between adjacent straight portions 50 in an alternating pattern so as to define a pair of segment ends 54 on the outermost straight portions 50. Each staright portion 50 is spaced a predetermined distance apart from adjacent straight portions 50, and as stated above, adjacent straight portions are joined by end turns 52. In one embodiment, this predetermined distance, upon insertion of conductor segment 46 into stator core 10, is equivalent to distance spanned by six (6) slots. It should be noted, however, that this is exemplary only and not meant to be limiting in nature.

In the illustrated embodiment, the wave spans two and one-half wave cycles, however, it should be noted that this arrangement is simply exemplary, and not limiting in nature. In actuality, the wave may span n/2 wave cycles, wherein “n” is any integer greater than zero. The wave-shaped segments can be constructed such that the total number of straight portions 50 disposed into the slots are continuously connected by a single wave. Alternatively, to improve handling in manufacturing, these wave-shaped segments may be independent, requiring post-insertion connections to complete the winding circuit.

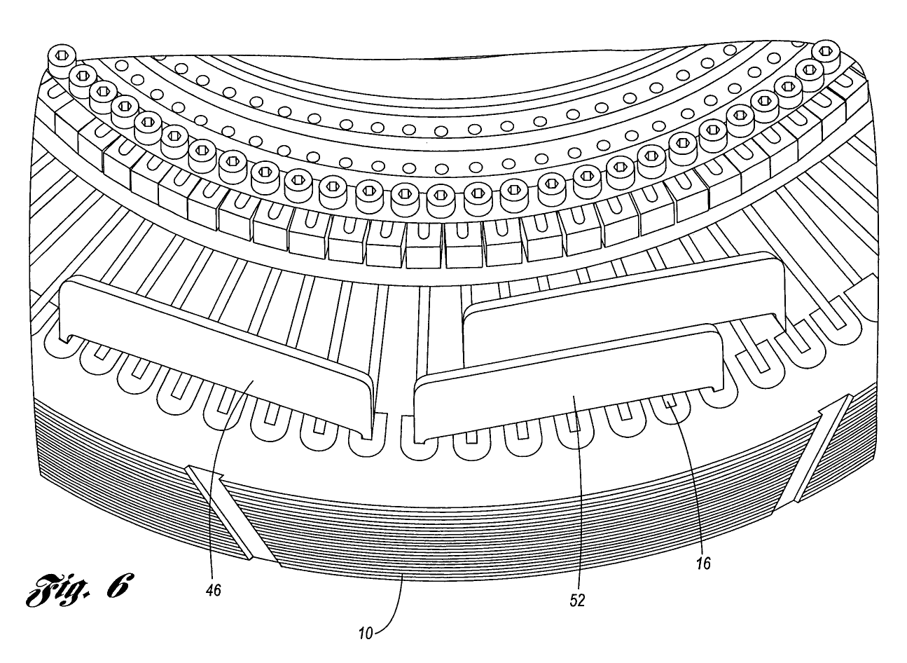

Next, as can be seen in FIGS. 4-4a, straight portions 50 of the wave-shaped conductor segment 46 are shaped into a second cross-section shape 56 which is different than first cross-section shape 48. FIG. 4a is a cross-sectional view of one of straight portions 50 as taken along line 4a-4a in FIG. 4, and shows straight portion 50 having a rectangular cross-section shape. The resulting rectangular cross-section shape 56 has a cross-section height 58 and a cross-section width 60, wherein width 60 is substantially equal to the slot width 20, thereby allowing for the maximization of the conductor area in the slot. It should be noted that in another embodiment of the present invention, only so much of straight portions 50 that are to occupy slot 16 are shaped into second cross-section shape 56. Cross-section height 58 is determined by the total number of conductors present in the slot. It should be further noted that this rectangular shape is only exemplary and not limiting in nature.

FIGS. 5-5a show how end turn regions 52 of the wave-shaped conductor segment 46 are shaped into relatively thin rectangular shaped cross-section, thereby defining a third cross-section shape 62, which is different from both first cross-section shape 48 and second cross-section shape 56. FIG. 5a is a cross-section view of end turn region 52 taken along the line 5a-5a in FIG. 5, and shows end turn region 52 having a rectangular cross-section shape. The resulting third cross-section shape 62 has a major extent 64 having a height that is greater than cross-section width 58 of straight portion 50, and a minor extent 66 having a width less than cross-section height 60 of straight portion 50. By shaping end turn region 52 in this manner, the height of the end turn regions 52 is substantially reduced in comparison to the end turns of hairpin-shaped windings, thereby allowing for simpler winding of the stator, as well as for the meeting of aggressive stator packaging constraints. The width of cross-section 66 is substantially determined by the total number of end turn regions 52 that cross-over each other in the slot region 30 and yoke region 12. Changing the cross-section 62 of the conductor in end turn region 52 eliminates conductor interference in the region allowing for an increase in space utilization, thereby decreasing the over height of end turns 52. To maintain cross-sectional area of the original conductor, as dimension 66 decreases, dimension 64 increases proportionally. Additionally, the resulting lower height end turn regions 52 reduce the overall resistance of the electrical machine thereby increasing its efficiency. It should be noted, however, that this rectangular shape is only exemplary and not limiting in nature.

The steps of forming the various shapes may be performed in any order.

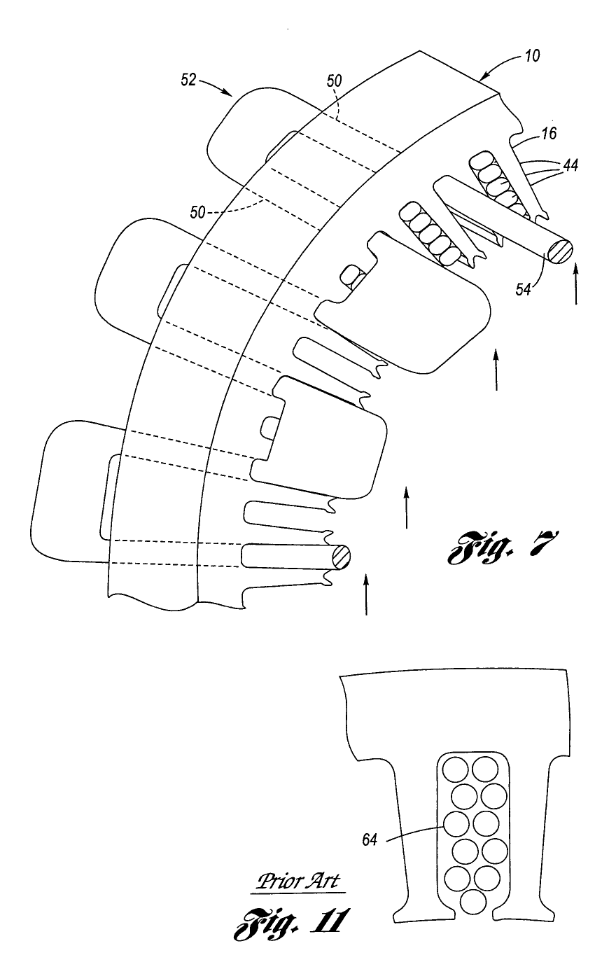

FIGS. 6-8 show the next step of the inventive method, namely, inserting formed wave-shaped conductor segment 46 into the slots 16. In the illustrated embodiment, wave-shaped conductor segment 46 is inserted in a radially-outwardly direction from central bore 18 (best shown in FIG. 1) through the slot openings 22 and into slots 16. This is accomplished, in one embodiment, by the method disclosed in Applicants' pending U.S. Application No. 20030048032A1, wherein the wave-shaped conductor segment 46 is loaded onto a radial insertion tool 67 (shown in FIG. 6), and then radially disposing segments 46 into the open slots. It should be noted, however, that other insertion techniques exist, such as axial insertion, that are within the spirit and scope of the invention. Upon insertion into stator core 10, both segment ends 54 are positioned on the same axial side of stator core 10 (best shown in FIGS. 7-8). It should be noted that the number of slots that wave-shaped conductor segment 46 spans inbetween adjacent straight portions 50 may vary depending upon the number of slots 16 with which stator core 10 is constructed, and whether the stator is of the full pitch or fractional pitch type. For instance, if stator core 10 is formed with 72 slots, each half cycle of wave-shaped conductor segment 46 may span six (6) slots. If, however, stator core 10 is formed with 36 slots, each half cycle of wave-shaped stator winding may span three (3) slots. Of course it should be clearly understood that these two configurations of stator core 10 are meant only to be exemplary and not limiting in nature.

As can be seen in FIG. 12, this insertion step can then be repeated a preselected number of times so that all of the slots 16 are occupied by a wave-shaped conductor segment 46. Once the desired number of wave-shaped conductor segments 46 are inserted into stator core 10, the respective segment ends 54 of adjacent inserted conductors are then connected, as known for hairpin conductor segments, thereby creating a continuous stator winding. Use of a plurality of wave-shaped conductor segments 46 as opposed to conventional hairpin-shaped conductor segments allows for a reduced number of required electrical connections between adjacent windings, thereby decreasing costs and reducing complexity. It should be noted, however, that the wave-shaped segments 46 may be manufactured such that no connections are required in each phase (i.e., the wave-shaped segments for a specific phase winding are all in series).

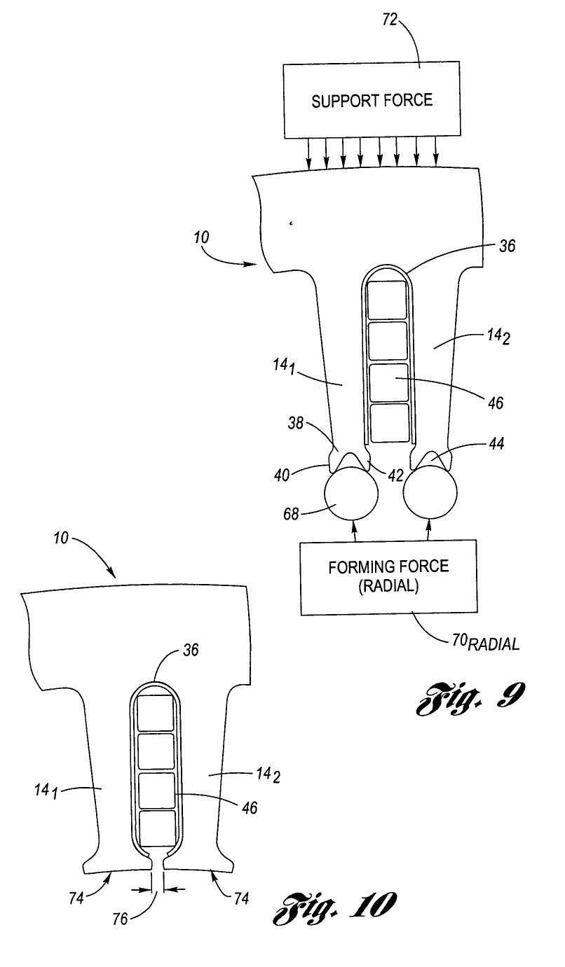

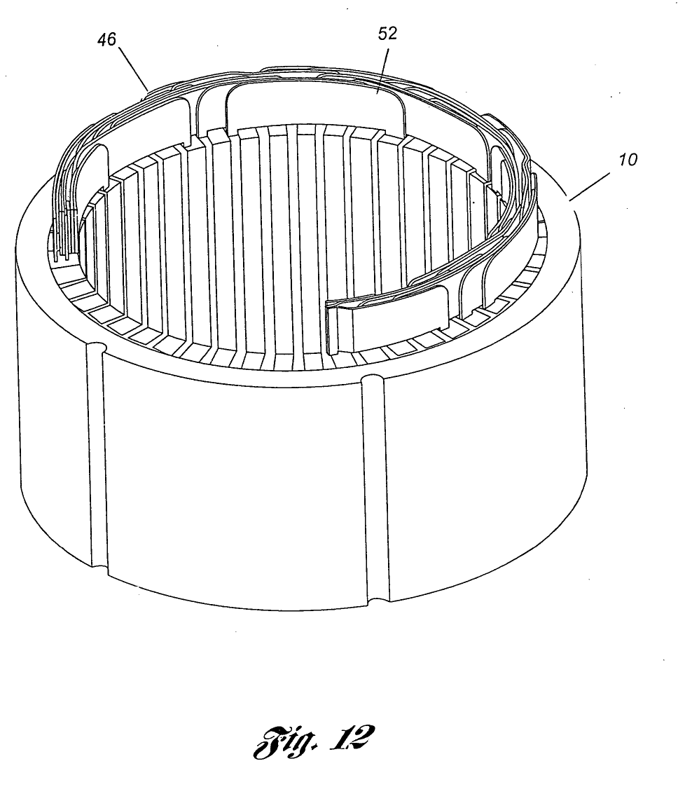

The method may include the further step of inserting a stator slot liner (insulator) 36 in slot 16 (FIGS. 9-10). Alternatively, the slot liner 36 can be omitted and a coating of electrically insulating material can be used in lieu thereof (powder coat epoxy, etc.). The wave-shaped conductor segment 46 would be inserted after the slot liner 36, if used.

FIG. 9 shows the next stage, particularly, the beginning of a cold-forming operation on the radially innermost ends of teeth 14₁ and 14₂ to form the final tooth tips. FIG. 9 shows a suitably configured forming tool (e.g., a ball with a size selected to effect the desired radius, and arranged in a ball roller configuration 68). Ball roller 68 is shown disposed against legs 40 and 42 of teeth 14. FIG. 9 also shows the radial forces, designated 70_{RADIAL} that are applied during the cold-forming operation. A support force, designated support force 72, is employed such as by providing a reaction surface or in other known ways.

The ball roller 68 may be rolled along the bottom of tooth 14 (i.e., the inside diameter of the stator core 10) in an axial direction. This movement deforms the material at the bottom (i.e., radially innermost) of tooth 14 to define a final “tooth tip” 74 (shown in FIG. 8). It should be noted, however, that this method of wire retention is exemplary only, and not limiting in nature. In another embodiment, stator 10 may be designed without pole tips, but with open slots having wedges located within the slots so that after the insertion of the conductor, the wedges will serve to retain the conductor within the slots.

FIG. 10 illustrates the final or completed stage where the final tooth tip 74 is newly formed on a radially innermost portion of each tooth 14. As a result of the cold-forming operation, a second slot opening width 76 is established that is smaller than the first slot opening width 24 shown in FIG. 2. The closed up slot width 76 provides an improved magnetic flux path, and further functions to retain the wave-shaped stator windings 46. The tooth tips are particularly important at low rotational speeds, such as may be experienced during idle or slightly faster than idle conditions in an automotive vehicle (e.g., 1600 rpm). In one configuration, the tooth tips improved the output amps of an alternator having normally “straight sided” stator teeth, such as shown by example only in U.S. Pat. No. 6,278,213 issued to Bradfield entitled “HIGH FILL STATOR DESIGN,” hereby incorporated by reference.

In accordance with the invention, an enlarged stator slot opening is combined with a wave-shaped conductor segment having two segment ends with a first cross-section shape and positioned on the same axial side of the stator upon insertion into the stator core (although, if design requires, the segment ends may exit on opposite ends of the stator if necessary), a plurality of straight portions with a second cross-section shape different than the first cross-section shape wherein the width of the straight portions is substantially equal to the width of one of the slots in the stator core, and a plurality of end turn regions with a third cross-section shape different than the first and second cross-section shapes, and sized to a width that eliminates interference between conductors passing in the end turn region, wherein the end turns are disposed inbetween straight portions in an alternating pattern. The wave-shaped conductor segment is inserted in a radially-outwardly direction starting from the central bore through the slot openings and into the slots, and then the tooth tips are cold-formed on the radially-innermost ends of the stator teeth. The features of the invention allow the wave-shaped conductor segment to be inserted radially through an increased-size slot opening compared to the slot openings found in conventional arrangements. The segment ends of adjacent wave-shaped conductor segements can then be connected to form a single continuous stator winding. The use of wave-shaped conductor segments having different cross-sections in the winding ends, straight portions, and end turn regions allows for reduced electrical connections, complexity and cost as compared to the conventional methods discussed above, and because these windings can be radially inserted, this invention allows for higher slot fill as well as increased generator output and efficiency afforded by the post winding cold forming process. The change in cross-section in the end turn region allows for the minimization of coil heights because of the thickness of the conductor is designed to eliminate interference between conductors in the region. This allows for a stator with a lower coil resistance, and thereby also reduces the cost of the product due to the elimination of unnecessary copper in the end turn region. The closed-up slot opening, which is now reduced in width (akin to a conventional slot opening), provides an improved magnetic flux path and performance (particularly at low speed), and further provides a wire retention function.

It should be noted that when forming the cross-section of the end turn regions, the change in cross-section may be so dramatic that the magnetic wire insulation typically on the round conductor will be overly stressed and damaged due to the significant increase in the perimeter of the new cross-section. Accordingly, in alternate embodiments, in the extreme case where the insulation will not survive the forming process, uninsulated copper wire will be used. This will be cheaper to purchase, and the savings will need to be used to post insulate the formed wave prior to inserting it into the stator core. Another option would be to place an open meshed sleeving over the entire wave-shaped segment, and then insert it into the stator. In this embodiment, no slot liner would be required. Rather, the mesh sleeve would provide a space factor between all of the conductor inserted into the stator. Next, an electrically insulating material such as a varnish or potting compound would be placed over the windings in the core, providing the necessary dielectric strength to isolate the conductors. If the insulation can survive the wave forming process, it may be desirable to place a “bondable” top coat on the conductor so that after insertion, the bondable coating can be heat activated to bond and lock the segments together as required for AC electric machines.

1. A method for making a dynamoelectric machine comprising the steps of:
providing a stator core having a main axis and a secondary axis, said secondary axis being parallel to, and radially offset from, said main axis, said core further including a plurality of teeth projecting radially inwardly to define a central bore, said plurality of teeth being separated by intervening slots having slot openings;
forming a continuous wave-shaped conductor segment out of a continuous conductor, said wave-shaped conductor segment having a plurality of straight portions extending longitudinally along and parallel to said secondary axis, a plurality of end-turn regions extending transverse said secondary axis and disposed in between said straight portions in an alternating pattern so as to define a pair of free segment ends on outermost straight portions, said free segment ends having a first cross-sectional shape, said straight portions having a second cross-sectional shape different than said first shape, and said end-turn regions having a third cross-sectional shape different than said first or second cross sectional shapes; and
inserting said wave-shaped conductor segment so as to be received in said slots at intervals of a predetermined number of slots.

2. The method of claim 1 further comprising the substeps of:
providing said stator core such that said teeth include unformed tooth tips that define said slot openings; and
deforming said unformed tooth tips so as to reduce said slot openings.

3. The method of claim 1 wherein the forming step further comprises the substep of:
fashioning said wave-shaped conductor segment so as to span one or more wave cycles.

4. The method of claim 1 wherein the forming step further comprises the substep of:
fashioning said wave-shaped conductor segment so as to span n/2 wave cycles wherein n is an integer greater than or equal to 1.

5. The method of claim 4 wherein the fashioning step includes fashioning said wave-shaped conductor segment in a manner in which n=7.

6. The method of claim 1 wherein the forming step further comprises the substep of:
shaping said wave-shaped conductor segment so that both of said free segment ends are on the same axial side of said stator core.

7. The method of claim 1 wherein the forming step includes forming said continuous wave-shaped conductor segment out of a conductor having a circular cross section shape.

8. The method of claim 7 wherein the forming step further includes the substep of:
reshaping the said straight portions of said conductor segment into a rectangular cross-section shape having a width and a height, and wherein the width of said straight portions is substantially equal to the width of said slot, thereby defining said second cross-section shape that is different than said first cross-section shape.

9. The method of claim 8 wherein the reshaping step farther includes the substeps of:
limiting said reshaping of the second cross section geometry to only the area of said straight portion that occupies said slots upon insertion into said stator core.

10. The method of claim 7 wherein the forming step further includes the substep of:
reforming said end turn regions of said conductor segment into a rectangular cross-section shape having a major extent and a minor extent, and wherein said major extent is greater than the width of said second cross-section shape, and said minor extent is less than the height of said second cross-section shape, thereby defining a third cross-section shape that is different than said first cross section shape, and said second cross-section shape.

11. The method of claim 1 further comprising the steps of:
repeating said providing and inserting steps a preselected number of times so that all of said slots are occupied by said straight portions of said wave-shaped conductor segments; and
connecting respective first and second segment ends of the inserted adjacent wave-shaped conductors to form a continuous wave-shaped conductor segment.

12. The method of claim 1 further comprising the step of forming said wave-shaped conductor segment so as to traverse six (6) of said slots between each of said straight portions.

13. The method of claim 1 wherein the inserting step includes inserting said wave-shaped conductor segment into said slots through corresponding slot openings in a radially-outwardly direction from said central bore.

14. The method of claim 1 wherein the inserting step includes inserting said wave-shaped conductor segment into said slots in an axial direction.

15. The method of claim 2 wherein the deforming step further includes the substep of cold working the radially innermost portion of said tooth tips.

16. The method of claim 1 further comprising the step of inserting a slot insulating material in each of said slots wherein a combined width of each of said straight portions and said insulating material is substantially equal to the slot width.

17. A method of making a dynamoelectric machine comprising the steps of:
providing a stator core having a main axis and a secondary axis parallel to and radially offset from said main axis, said stator core further including a yoke and a plurality of teeth projecting radially inwardly away from said yoke to define a central bore, wherein each of said teeth includes a tooth tip having a radially innermost portion and including a pair of legs with a recess disposed therebetween;
providing a plurality of slots formed between two of said plurality of teeth, each slot extending axially for the entire length of said stator core, and wherein each slot includes two sides, an open end located between the tooth tips of consecutive teeth, and a closed end adjacent to said yoke;
forming a continuous wave-shaped conductor segment having a first cross-section shape, and further being comprised of a plurality of straight portions extending longitudinally along and parallel to said secondary axis with end-turn regions extending transverse said secondary axis and disposed in between said straight portions in an alternating pattern so as to define a pair of free segment ends on outermost straight portions, said free segment ends having a first cross-sectional shape, said straight portions having a second cross-sectional shape different than said first shape, and said end-turn regions having a third cross-sectional shape different than said second shape;
shaping said wave-shaped conductor segment so that both free segment ends are on the same axial side of said stator core;
fashioning said wave-shaped conductor segment so as to span one or more wave cycles;
inserting said wave-shaped conductor segment so as to be received in said slots at intervals of a predetermined number of slots;
repeating said providing and inserting steps a preselected number of times so that all of said slots are occupied by said straight portions of said wave-shaped conductor segments;
connecting respective first and second segment ends of the inserted adjacent wave-shaped conductor segments to form a continuous stator winding; and
deforming said unformed tooth tips so as to reduce said slot opening.

18. The method of claim 17 wherein the forming step further comprises the substep of:
fashioning said wave-shaped conductor segment so as to span n/2 wave cycles wherein n is an integer greater than or equal to 1.

19. The method of claim 18 wherein the fashioning step includes fashioning said wave-shaped segment conductor in a manner in which n=7.

20. The method of claim 17 wherein the forming step includes forming said continuous wave-shaped conductor segment out of a conductor having a circular cross section shape.

21. The method of claim 20 wherein the forming step further includes the substep of:
reshaping said straight portions of the conductor segment into a rectangular cross section shape having a width and a height, and wherein the width of said straight portions is substantially equal to the width of said slot, thereby defining said second cross section shape different than said first cross-section shape.

22. The method of claim 21 wherein the reshaping step further includes the substeps of:
limiting said reshaping of the second cross section geometry to only the area of said straight portion that occupies said slots upon insertion into said stator core.

23. The method of claim 20 wherethe forming step further includes the substep of:
reforming the end turn regions of the winding into a rectangular cross section shape having a major extent and a minor extent, and wherein said major extent is greater than the width of said second cross-section shape, and said minor extent is less than the height of said second cross-section shape, thereby defining a third cross-section shape that is different than said first cross-section shape and said second cross section shape.

24. The method of claim 17 further comprising the step of forming said wave-shaped conductor segment so as to traverse six (6) of said slots between each of said straight portions.

25. The method of claim 17 wherein the deforming step further includes the substep of cold working the radially innermost portion of said tooth tips.

26. The method of claim 17 wherein the inserting step includes inserting said wave-shaped conductor segment into said slots through corresponding slot openings in a radially-outwardly direction from said central bore.

27. The method of claim 17 wherein the inserting step includes inserting said wave-shaped conductor segment into said slots in an axial direction.

28. The method of claim 17 further comprising the step of inserting a slot insulating material in each of said slots wherein a combined width of each of said straight portions and said insulating material is substantially equal to the slot width.

29. A stator for dynamoelectric machines, comprising:
a core having a main axis and a secondary axis, said secondary axis being parallel to, and radially offset from, said main axis;
a plurality of teeth projecting radially-inwardly from said stator core to define a central bore, said plurality of teeth being separated by intervening slots having slot openings; and
a plurality of wave-shaped winding segments disposed within said plurality of slots, each of said wave-shaped conductor segments having a plurality of straight portions extending longitudinally along and parallel to said secondary axis, a plurality of end-turn regions extending transverse said secondary axis and disposed in between said straight portions in an alternating pattern so as to define a pair of free segment ends on outermost straight portions, said free segment ends having a first cross-sectional shape, said straight portions having a second cross-sectional shape different than said first shape, and said end-turn regions having a third cross-sectional shape different than said first or second shapes, and further wherein said adjactent wave-shaped winding segments are electrically connected to each other to form a continuous stator winding.

30. A stator in accordance with claim 29 wherein said plurality of teeth include unformed tooth tops that define said slot openings, and wherein said unformed tooth tips are deformed so as to reduce said slot openings after said plurality of wave-shaped conductor segments are inserted into said slots.

31. A stator in accordance with claim 29 wherein each of said wave-shaped conductor segments span one or more wave cycles.

32. A stator in accordance with claim 29 wherein each of said wave-shaped conductor segments span n/2 wave cycles wherein n is an integer great than or equal to 1.

33. A stator in accordance with claim 32 wherein n=7.

34. A stator in accordance with claim 29 wherein both of said free segment ends are located on the same axial side of said stator core.

35. A stator in accordance with claim 29 wherein said free segment ends have a circular cross-sectional shape thereby defining said first cross-sectional shape, said straight portions have a rectangular cross sectional shape thereby defining said second cross-sectional shape, and said end-turn regions have a rectangular cross-sectional shape different than said second cross-sectional shape thereby defining said third cross-sectional shape.

36. A stator in accordance with claim 29 further comprising an insulating material disposed within said slots.
